(19) United States
(12) Patent Application Publication
(10) Pub. No.: US 2017/0052959 A1
(43) Pub. Date: Feb. 23, 2017

(54) Filtering Resources Using a Multilevel Classifier

(71) Applicant: Deloitte Global Services Limited, London (GB)

(72) Inventors: Jonathan Felske, Kanata (CA); Peter Myers, Toronto (CA); Eziah Syed, New York, NY (US); Delfin Montuno, Kanata (CA); Kent Felske, Kanata (CA)

(21) Appl. No.: 15/240,122

(22) Filed: Aug. 18, 2016

Related U.S. Application Data
(60) Provisional application No. 62/206,366, filed on Aug. 18, 2015.
(60) Provisional application No. 62/332,946, filed on May 6, 2016.

(51) Int. Cl. G06F 17/30; G06N 3/04; G06N 3/08

(52) U.S. Cl. CPC G06F 17/3053; G06N 3/08; G06N 3/04

(57) ABSTRACT

A method of filtering and scoring a plurality of resources where each resource can be associated with a plurality of attribute values. For each resource at least a subset of the attribute values can be applied to an input layer of a multilevel classifier, such as a neural network. The multilevel classifier can be used to generate intra-level values for nodes in an intermediate layer of the multilevel classifier and output values for node at an output layer of the multilevel classifier. The output values and associated intra-level values can be used to determine a confidence indicator or qualification score for the resource. The confidence indicators or qualification scores for the resources can be compared to filter the resources.

### CROSS REFERENCES TO RELATED APPLICATIONS

This application is related to and claims priority benefits of U.S. Provisional Application No. 62/206,366 (“the '366 application”), entitled “System and Method for Adapting and Executing a Process Using Artificial Intelligence and Machine Learning” by inventors Pete Myers, Jonathan Felske, and Eziah Syed, filed Aug. 18, 2015. The '366 application is hereby incorporated in its entirety by this reference.

This application is related to and claims priority benefits of U.S. Provisional Application No. 62/332,946 (“the '946 application”), entitled “Computing Confidence Indicators of a Classification of Multilevel Classifiers” by inventors Jonathan Felske, Delfin Montuno, Kent Felske, Peter Myers, and Eziah Syed, filed May 6, 2016. The '946 application is hereby incorporated in its entirety by this reference.

### TECHNICAL FIELD

The present disclosure relates generally to filtering resources using a multilevel classifier, and more particularly (although not necessarily exclusively), to filtering the resources based on compatibility with user requirements and a qualification of the resources.

### BACKGROUND

Financial statement audits are a task performed by independent auditors to provide assurance that an entity's financial statements are stated in accordance with generally accepted accounting principles. The audit process can be complex and certified auditors can be obtained to provide audit opinions on financial statements for businesses, non-profit organizations, and government agencies. Each audit can be customized to meet the needs of the organization. The process of searching for auditors and evaluating their qualifications can require substantial effort. A client needing an auditor may choose to hire an auditor through word of mouth or past experience. Even when a wide selection of auditors is readily available, filtering the available auditors can be cumbersome. An auditor may need an audit team formed from either internal resource or external resources to ensure the auditor has the skill set to perform an audit for a specific client. Auditors can incur certain risks and liabilities when staffing. For example, the risk could in part be due to a poor quality of service rendered by a hired service agent and the ensuing legal liability from being sued by the client.

Multilevel classifiers can include neural networks that determine a classification for a resource (e.g., a potential auditor, potential audit staff, or a potential investment). A classification may be a numerical score or may be a qualitative category such as risky or solid. In some examples, service providers such as auditors, healthcare providers, and cyber security organizations can perform risk assessments focused from the organizational to the individual level. When the turnover rate is high, the service providers can be pressed to find suitable service agents without incurring upon themselves certain risk and liability. The service providers can benefit from minimizing, for example, the performance risk of service agents and the possibility of legal liability from service recipients. A multilevel classifier can classify a service agent based on information related to the service agent such that a service provider can select a service agent based on the classification.

### BRIEF DESCRIPTION OF THE DRAWINGS

FIG. 1 is a block diagram of an example of a cloud based audit platform according to one aspect of the present disclosure.

FIG. 2 is a flow chart of an example of a process of selecting a resource using a compatibility test and a qualification test according to one aspect of the present disclosure.

FIG. 3 is a flow chart of an example of a process of selecting a candidate using a compatibility test on qualified candidates according to one aspect of the present disclosure.

FIG. 4 is a flow chart of an example of a process for computing a qualification score using an intra-level value of a multilevel classifier according to one aspect of the present disclosure.

FIG. 5 is a flow chart of an example of a process for computing a premium rate using an intra-level value of a multilevel classifier according to one aspect of the present disclosure.

FIG. 6 is a block diagram of an example of the data processing module used in part of the process in FIGS. 4-5 according to one aspect of the present disclosure.

FIG. 7 is a block diagram of an example of a neural network architecture according to one aspect of the present disclosure.

FIG. 8 is a block diagram of an example of another neural network architecture according to one aspect of the present disclosure.

FIG. 9 is a graph of an activation function used in the nodes of the output layer of a neural network.

FIG. 10 is a block diagram of an example of the neural network architecture in FIG. 7 for illustrating the computation of an intra-level value according to one aspect of the present disclosure.

FIG. 11 is a block diagram of an example of the neural network architecture in FIG. 8 for illustrating the computation of another intra-level value according to one aspect of the present disclosure.

FIG. 12 is a block diagram of a computing device for determining a resource according to one aspect of the present disclosure.

### DETAILED DESCRIPTION

Certain aspects and features relate to filtering one or more resources based on a compatibility score of a resource and a qualification score of the resource. The qualification score of the resource can be determined by using both intra-level values and output values from a multilevel classifier. The intra-level value can be based on the intermediate data used in the process of determining a classification level of the resource. Two resources with the same classification level can be differentiated based on the intra-level value. As a result two resources with the same output values or classification level can receive different qualification scores. The compatibility score can be determined by performing a compatibility test to compare the preferences of a user with attributes of a resource.

Using intra-level values in addition to output values can provide greater precision without increasing the complexity of the multilevel classifier. In some examples, using both values from a multilevel classifier provides similar precision to using only output values from a multilevel classifiers with a greater number of classification levels. Reducing the number of classification levels can reduce the training time, memory usage, and processing requirements associated with a multilevel classifier and thus improve the operation of the system.

A system can implement a neural network to evaluate resources. A neural network can be trained to estimate an output for a complex problem (e.g., classifying a resource compared to other resources) based on learning from a large number of inputs (e.g., resources). The neural network can be used as a multilevel classifier with machine learning to filter and suggest one or more resources for selection by a user. For example, the system can provide an audit platform that includes a cloud based audit component, an auditor selection component, and a staffing component. Each of these components may interact with other components, systems and users, including but not limited to a client (e.g., a company undergoing an audit) and service providers (e.g., an auditor) or other entities that support the audit. The system can assist clients in finding an auditor by filtering potential auditors using the compatibility test and the qualification test. In some aspects, the system can filter the potential auditors based on the compatibility test component for a quick prescreening of the potential auditors. For example, the system can compare a skill set of an auditor with the requirements of a task desired by a client.

In some aspects, the system can use the qualification test to compare available auditors. For example, available auditors can be compared based on attributes, such as educational background, service history, employer relationship, credit history, service area, service requirement, and reputation of a service agent. The system can allow for a computation of the qualification score based on a classification level. In the case of a tie in the classification level, the distinction between auditors can be based on an intra-level value. The intra-level value can be based on the intermediate data used to compute the classification level. In some cases, a more accurate qualification level can be computed using the intra-level value and can be based on the outputs and intermediate values of all classification mechanisms. In some aspects, the compatibility score and qualification score can be used independently to filter the potential auditors. In additional or alternative aspects, the results of filtering based on the compatibility or qualification can enhance the filtering of the other.

In additional or alternative examples, resources can include investment opportunities. Attributes of an investment opportunity may include transparency, public opinion, financial ratios (e.g., debt to equity), and risks (e.g., supply chain risk and legal risk) of a company.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

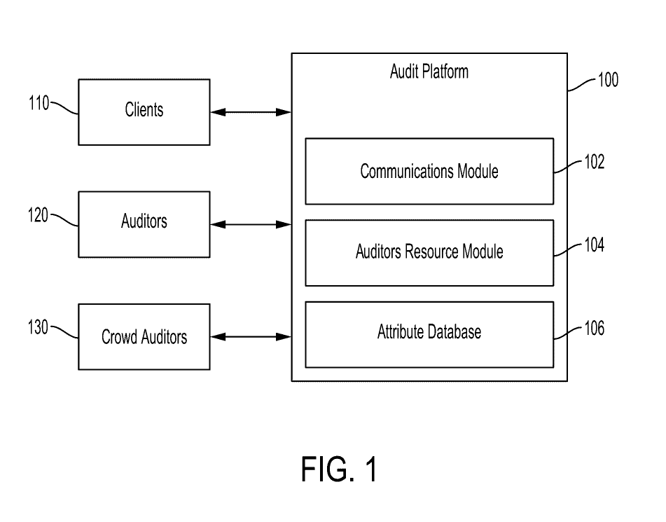

FIG. 1 is a block diagram of an example of a cloud based audit platform 100 communicatively coupled to clients 110, auditors 120, and crowd auditors 130. The audit platform 100 can include a communications module 102, an auditors resource module 104, and an attribute database 106. In some examples, the audit platform 100 can further include an audit completeness module, audit analysis module, workflow analysis module, workflow module, and auditing module as well as audit data, audit test cases, audit results, and workflow optimization stored in another database. Local data can also be available for the auditors resource module 104 and communication module 102.

Clients 110, Auditors 120, and crowd auditors 130 can access the audit platform 100. The client 110 can have a client database, client controls test results, and client controls test cases. Supporting financial information can be communicatively coupled to the audit platform 100 and can include data related to the client 110 extracted from external sources such as social and news media. The communication module 102 can be used by the auditor 120 and client 110 to establish and conduct an audit engagement. The auditors resource module 104 can allow client 110 to find an auditor 120 and the auditor 120 to manage the crowd sourcing of external auditors, crowd auditors 130. The audit process may include additional audit resources. For example, using crowd sourcing the number of available candidates could be overwhelming and to address such a situation, auditors resource module 104 can quickly prescreen a set of suitable candidates.

The audit platform 100 can implement a neural network as a multilevel classifier with machine learning to filter and suggest one or more auditors 120 for selection by a client 110. The audit platform 100 can assist clients 110 in finding an auditor 120 by filtering potential auditors 120 using a compatibility test and a qualification test. In some aspects, the compatibility score and qualification score can be used independently to filter the potential service agents. In additional or alternative aspects, the results of filtering based on the compatibility or qualification can enhance the filtering of the other.

The audit platform 100 can create profiles of the auditors 120 that use the system. The profiles can include attributes such as years of experience, industry expertise, client rating, prior engagements, average cost, and other attributes that can be maintained in the attribute database 106. The audit platform 100 can enable the auditors 120 to choose to be visible by potential clients 110. This “available for a job” feature can be activated or deactivated by the auditor 120 at any time and allows the auditor to be considered for an engagement without requiring that the auditor apply or otherwise request consideration for a specific engagement. The audit platform 100 can enable clients 110 to search for auditors 120 based on the attribute criteria and filter auditors 120 by each attribute field. The audit platform 100 can include a component that performs independence checks to ensure the auditor 120 is qualified to perform an audit on that particular engagement. The audit platform 100 can enable the client 110 to select auditors 120 from the filtered list of auditors 120. Once selected for a job, the audit platform 100 can migrate the auditor information and client information into the audit software to complete the engagement.

The audit platform 100 can also connect and enable the auditors 120 using the audit platform 100 to participate in a crowd workforce and accept temporary audit engagement offers from crowd auditors 130. The audit platform 100 can enable the communications module 102 to connect to external professional crowd marketplaces. The audit platform 100 can enable a lead auditor to post multiple jobs to the internal and/or external crowd. The audit platform 100 can also enable internal or external talent to bid on the available jobs. The audit platform 100 can further enable the lead auditor to filter talent by criteria and to perform an online interview of selected candidates. The audit platform can enable the lead auditor to award a job to a candidate and migrate the candidate into the audit software to perform the engagement. Once the candidate is migrated into the audit software, the system can create an audit engagement team in a closed electronic workspace.

The audit platform 100 can filter its available resources based on a qualification score. The qualification score can be computed by the audit platform 100 using a multilevel classifier to determine a classification level for the available resources. In some aspects, a subset of the resources is based on their classification level and further differentiated by determining an intra-level value for each resource. In additional or alternative aspects, the multilevel classifier may be trained to compute confidence indicators such that each potential resource is classified with a confidence indicator. For example, audit staffers may be classified by a multilevel classifier, and confidence indicators may be computed to allow more precise comparison between the audit staffers. In some examples, a compatibility test can be performed on potential resources to determine their suitability based on preference of a user (e.g., a client 110 or an auditor 120).

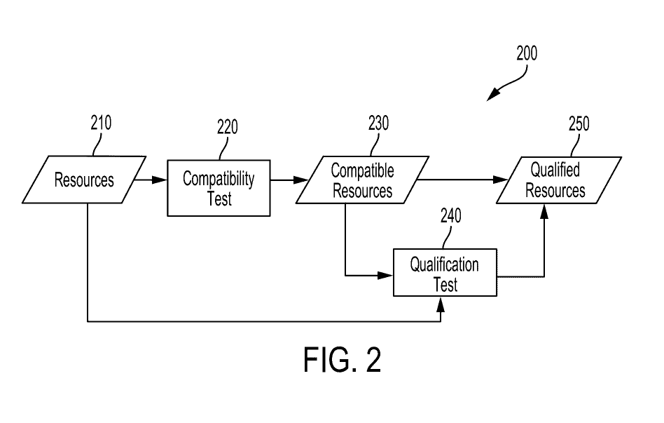

FIG. 2 is a flow chart of a process 200 of determining qualified resources 250 using a compatibility test 220 and a qualification test 240. In some aspects, resources 210 are evaluated by a compatibility test 220. The compatibility test 220 can output a subset of the resources 210 as compatible resources 230. In some examples, the compatible resources 230 can be determined to be qualified resources 250. In other examples, the compatible resource 230 can be evaluated by a qualification test 240. The qualification test can output a subset of the compatible resources 230 as the qualified resources 250. In additional or alternative aspects, the resources 210 can be evaluated by the qualification test 240, which can output a subset of the resources 210 as qualified resources 250.

In some aspects, a qualification score for each resource can be determined by the qualification test 240 and a compatibility score for each resource can be determined by the compatibility test 220. Qualified resources 250 can be determined based on a combination of the qualification score and compatibility score. In some examples, the compatibility test 220 and the qualification test 240 output a subset of resources input based on the subset of resources receiving a score above a threshold value. In additional or alternative examples, the compatibility test 220 and the qualification test 240 can output a single resource with the highest score. In some aspects, qualified resources 250 can be displayed to a user for selection by the user.

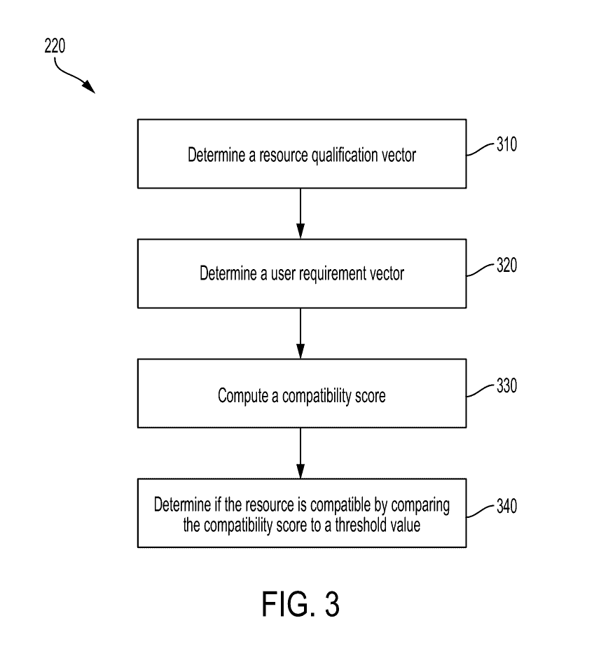

FIG. 3 is a flow chart of the compatibility test 220 in FIG. 2. The compatibility test 220 can be used to determine if a resource is compatible with a user. A resource can be compatible based on the resource having attributes preferred by the user. In some aspects, the resource can be an auditor and the user can be an audit client. In additional or alternative aspects, the resource can be an audit staffer and the user can be an auditor.

In block 310, a resource qualification vector can be determined. The resource qualification vector can be determined based on data from various sources including the resource and records of prior jobs performed by the resource. In some aspects, the resource qualification vector for a resource can be stored in a database and automatically updated as the attributes change.

In block 320, a user requirement vector can be determined. The user requirement vector can be determined based on the job requested by the user and specific preferences entered by the user.

The resource qualification vector and the user requirement vector can be different for each resource and user. In some aspects, the resource qualification vector and the user qualification vector can be normalized so that each attribute has a value between zero and one. For example, a user requirement vector for an auditor looking for an audit staffer can include attributes for years of experience (“Y”), years of education (“E”), and number of affiliations (“A”). Determining a vector (Y,E,A) can involve setting: Y=min(0.1*years of experience, 1), such that 10 years is the upper limit and more years of experience will have no additional weight, E=min(0.125*years of education, 1), such that 8 years is the upper limit and more years of education will have no additional value, and A=min(0.25*Sum(affiliations), 1), such that 4 affiliations is the upper limit and more affiliations will have no additional value.

In this normalization process, the first few years of experience may be weighted less than the latter years or the first few affiliations may be weighted more than the additional affiliations. In additional or alternative normalization processes, a subset of candidate qualifications can be used according to preferences by the user. In some aspects, a higher priority preference which would be a subset of all preferences can be used to filter the resources into a first subset of the resources and then subsequent filtering of the subset with additional preferences. For example, a multi-stage compatibility test can allow for determining if a resource has a skill set before determining if the resource has an acceptable financial cost. In additional or alternative aspects, a compatibility test can incorporate an interval value, wherein the amount of overlap of the resource attribute with the preferences of the user can be used in part for the normalization.

In block 330, a compatibility score can be computed. The compatibility score can be computed by a processing device that receives a list L as input, where L is defined as

L=((Cᵢ, Qᵢ), i=1,n)

where n is a number of resources, Cᵢ is the i^{th} resource identifier and Qᵢ is its corresponding normalized qualification vector. The input to block 330 can also include the normalized requirement vector the desired maximum number of compatible resources, MaxRes, where 1≦MaxRes≦n, and the threshold value set by the user, UserThreshold.

The output of block 330 can be a list of selected resources M and their corresponding compatibility scores. In some aspects, compatibility scores can be determined by

$$\frac{{Q}_{i} \cdot R}{‖ {Q}_{i} ‖ ‖ R ‖} , and M = ( ( {C}_{j} , \frac{{Q}_{i} \cdot R}{‖ {Q}_{i} ‖ ‖ R ‖} ) such that \frac{{Q}_{i} \cdot R}{‖ {Q}_{i} ‖ ‖ R ‖} \geq UserThreshold and j \leq MaxRes ) ,$$

For example, an auditor may have a user requirement vector R that is (1.0, 0.5, 0.75), meaning the auditor cares highly about experience, less of education, and more of affiliations, and a resource can have qualification vector Qᵢ is (1.0, 0.75, 0.5), meaning the resource has great experience, high education, and average affiliation, then

$$\frac{{Q}_{i} \cdot R}{‖ {Q}_{i} ‖ ‖ R ‖} = 0.9655 ,$$

where Qᵢ·R=1.75 and ∥Qᵢ∥∥R∥=1.8125.

In additional or alternative aspects, compatibility scores can be determined by observing the difference in length and angle of the qualification vector Qᵢ and the requirement vector R. The smaller the angle between Qᵢ and R the more aligned the resource qualification vector is with the user requirement vector. The greater the length of Qᵢ the higher the value of the resource's attributes. The length of a resource's qualification vector can be normalized by the length of the requirement vector such that resources with a length greater than 1 have attribute values above the requirements and resources with a length less than 1 have attribute values below the requirements. In some examples, the qualification vectors for several resources can be displayed to the user along with the requirement vector for quick identification by the user of compatible resources.

In block 340, the compatibility score can be compared to a threshold value to determine if the resource is compatible with the user. The threshold value can be set by the user or may be a predetermined value. In some aspects, the threshold value can be determined based on the compatibility score of the available resources such that a predetermined number of resources are determined to be compatible.

In some aspects, a tie between compatibility scores can be broken by adjusting the weight of different attributes. For example, a requirement vector can be rv=(1,1), a qualification vector for a first resource can be qv₁=(0,1) and a qualification vector for a second resource can be qv₂=(1,0) the compatibility scores between the requirement vector and the qualification vectors are as follows:

$$\frac{r \cdot {qv}_{1}}{‖ rv ‖ ‖ {qv}_{1} ‖} = cos ( 45 ° ) \frac{rv \cdot {qv}_{2}}{‖ rv ‖ ‖ {qv}_{2} ‖} = cos ( 45 ° )$$

The compatibility measures for both qualification vectors are equal. The tie can be broken by observing the results of

(qv₁−qv₂)·w,

where w=(w₁, . . . , wₙ) is the importance of each components of the requirement vector and 0≦wᵢ≦1 for 1≦i≦n. The value of (qv₁−qv₂)·w can be interpreted as follows:
if (qv₁−qv₂)·w>0, then qvᵢ is better suited than qv₂
if (qv₁−qv₂)·w==0, then qv₁ is equally suited as qv₂
if (qv₁−qv₂)·w<0, then qv₁ is less suited than qv₂
   Given a w, the value of w can be changed to cause differentiation between equal compatibility scores. The compatibility test can learn from the qualification test and adjust the w based on the results of the qualification test. For example, the results of a qualification test can be used to modify w if a compatibility test of two qualification vectors results in a tie, but the qualification vectors are associated with different qualification scores. The value of w can be changed such that (qv₁−qv₂)·w reflects the results of the qualification test.

Although process 220 depicts determining if a single resource is compatible, the process can be iterated to determine a subset of available resources that are compatible. For example, list M can be initialized to an empty list. For each (Cᵢ, Qᵢ) ∈ L, append

$$( {C}_{i} , \frac{{Q}_{i} \cdot R}{‖ {Q}_{i} ‖ ‖ R ‖} )$$

### to M. Sort

$$( {C}_{i} , \frac{{Q}_{i} \cdot R}{‖ {Q}_{i} ‖ ‖ R ‖} )$$

in M according to the value of

$$( \frac{{Q}_{i} \cdot R}{‖ {Q}_{i} ‖ ‖ R ‖} )$$

in decreasing order. The first MaxCan elements of the sorted M that are also above or equaled to UserThreshold.

The compatibility test 220 can be used for selecting any resource including a service agent, auditor, or audit staffer. In some examples, the compatibility test 220 can be used to create a pool of potential resources that meet a threshold level of compatibility and the pool of potential resources can be evaluated using a multilevel classifier to determine the most qualified compatible candidate. In additional or alternative examples, the compatibility test can be used on a pool of qualified candidates that have been classified as exceeding a threshold qualification level to determine the most compatible qualified candidate.

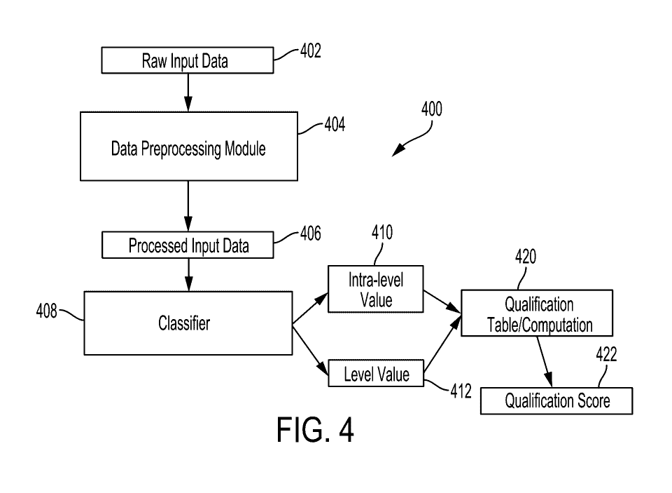

FIG. 4 is a flow chart of an example of a process 400 for computing a qualification score 422 of a resource using a multilevel classifier. The raw input data block 402 can designate data about the resource that can be normalized by the data preprocessing module 404. The data preprocessing module 404 can output the processed input data 406 that can be input to the classifier 408. The output of the classifier 408 can include a classification level 412, also referred to as a qualification level, which is based on one or more output values, and an intra-level value 410. The classification level 412 can be an indication of the qualification score 422 of the resource. The intra-level value 410 can be used by a qualification table 420 to provide a more precise qualification score 422 based on the classification level 412.

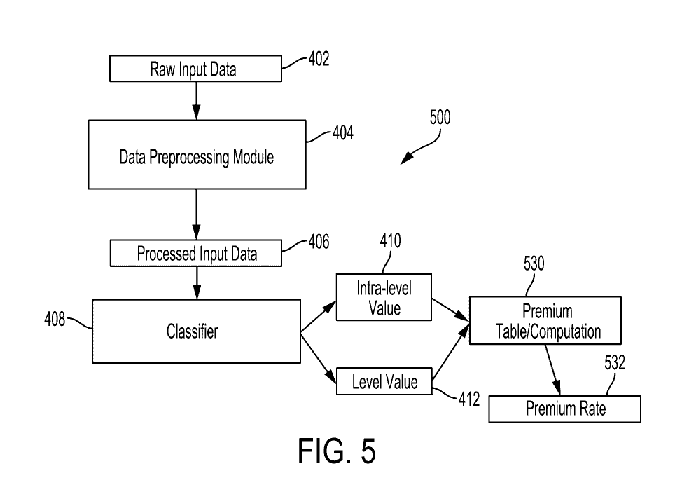

FIG. 5 is a flow chart of an example of a process 500 for computing a premium rate 532 using a multilevel classifier. The premium rate 532 can be a cost for a product such as insurance coverage. The cost of an insurance policy can be different for different insurees based on their risk level. The raw input data 402 can be data about a potential insuree, and the input data 402 can be used by data preprocessing module 404 to output processed input data 406. A classifier 408 can use the processed input data to determine a classification level 412 and an intra-level value 410 for the insuree. In some aspects, the classification level 412 can be qualitative such as “high risk” or “low risk.” In additional or alternative aspects, the classification level can be a quantitative evaluation of the insuree. A premium table 530 can use the classification level 412 and the intra-level value 410 to determine a premium rate 532 that the insurer should charge for the insurance policy. Using the intra-level value 410 to determine the premium rate 532 can provide a more accurate estimate of a premium rate.

A similar process to the processes 400, 500 in FIGS. 4 and 5 can be used in other applications including, but not limited to, investment scores and risk scores. In some aspects, the processes 400 and 500 can be implemented on a multilevel classifier such as a neural network. A multilevel classifier for these applications may have a similar topology to a multilevel classifier used for audit staffing or insurance, but will be trained using a different data set.

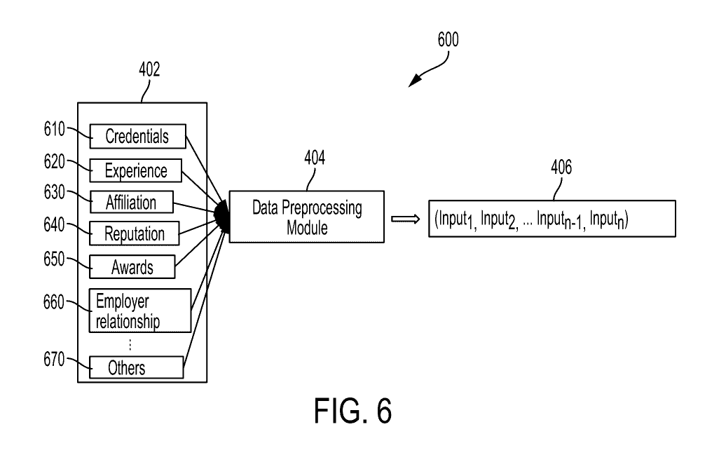

FIG. 6 is a block diagram of an example of components 600 for performing a portion of the process illustrated in FIGS. 4-5. The data preprocessing module 404 in FIGS. 4-5 can receive raw input data 402 related to a resource (e.g., an auditor) and output the processed input data 406. For example, the resource may be an auditor and the raw input data block 402 can include, in part, credentials 610, experience 620, affiliation 630, reputation 640, awards 650, and employer relationship 660 of the resource. The data preprocessing module 404 can output the processed input data 406 in a form suitable for input to the classifier 408.

Credentials 610 may include the ranking of the educational institutions graduated, number of years and relevancy of education, and number of years and relevancy of trainings. Experience 620 may include the ranking of organization/business involved, number of years and relevancy of services rendered. Affiliation 630 may include the ranking of organizations affiliated, and the number of years and relevancy of affiliation. Reputation 640 may include being positively or negatively viewed by social media. Awards 650 may include the number and relevancy of the awards. Employer relationship 660 may include being a first time or repeat personnel, and previous quality of service rendered. Others 670 may, for example, include credit history, an interview score, or an entrance exam score.

In additional or alternative aspects, a data preprocessing module can receive raw input data related to a different subject (e.g., a potential investment). Raw input data can include different data based on a type of resource for classification.

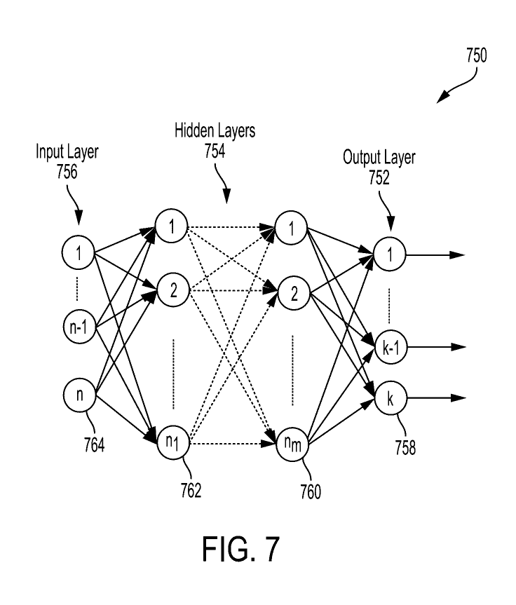

FIG. 7 is a block diagram of an example of a neural network architecture 750. Neural network architecture 750 has n input nodes 764 at the input layer 756; n₁ first nodes 762 at the first of the hidden layers 754 and nₘ last nodes 760 at the last of the hidden layers 754 or the m^{th} hidden layer 754; and k output nodes 758 at the output layer 752. Each input node 764 can be connected by an edge to one or more first nodes 762. Each first node 762 can be connected to one or more last nodes 760 by a series of edges and hidden nodes (not illustrated). In some aspects, each first node 762 can be connected by an edge directly to one or more last nodes 760. In additional or alternative examples, a first node 762 can be a last node 760. Each last node 760 can be connected by an edge to one or more output nodes 758. For the example illustrated in FIG. 7, the solid edges indicate direct connections and the dashed edges indicate indirect connections. For the neural network architecture 750, at most k distinct levels can be classified. A classification can be indicated, for example, by one of the output nodes 758 at the output layer 752 being set to 1 and the rest of the output nodes 758 being set to 0.

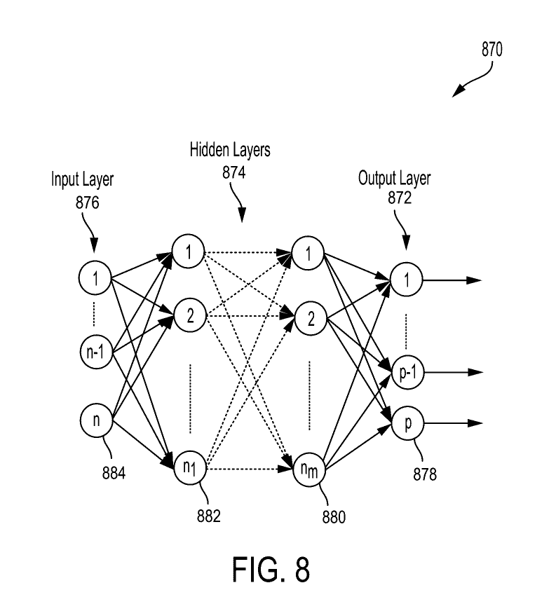

FIG. 8 is a block diagram of an example of another neural network architecture 870. Neural network architecture 870 has n input nodes 884 at the input layer 876; n₁ first nodes 882 at the first of the hidden layers 874 and nₘ last nodes 880 at the last of the hidden layers 874 or the m^{th} hidden layer 874; and p output nodes 878 at the output layer 872. The values of n, n₁, nₘ, and m used in FIG. 8 do not have to be the same as those used in FIG. 7. Each input node 884 can be connected by an edge to one or more first nodes 882. Each first node 882 can be connected to one or more last nodes 880 by a series of edges and hidden nodes (not illustrated). In some aspects, each first node 882 can be connected by an edge directly to one or more last nodes 880. In additional or alternative aspects, a first node 882 can be a last node 880. Each last node 880 can be connected by an edge to one or more output nodes 878. For the example illustrated in FIG. 8, the solid edges indicate direct connections and the dashed edges indicate indirect connections.

The architecture 870 encodes the classification in the p output nodes 878 with the output of each output node 878 representing a binary digit. By associating each classification with a binary number and each output node 878 representing a single binary digit, architecture 870 can have at most 2^{p} distinct classifications.

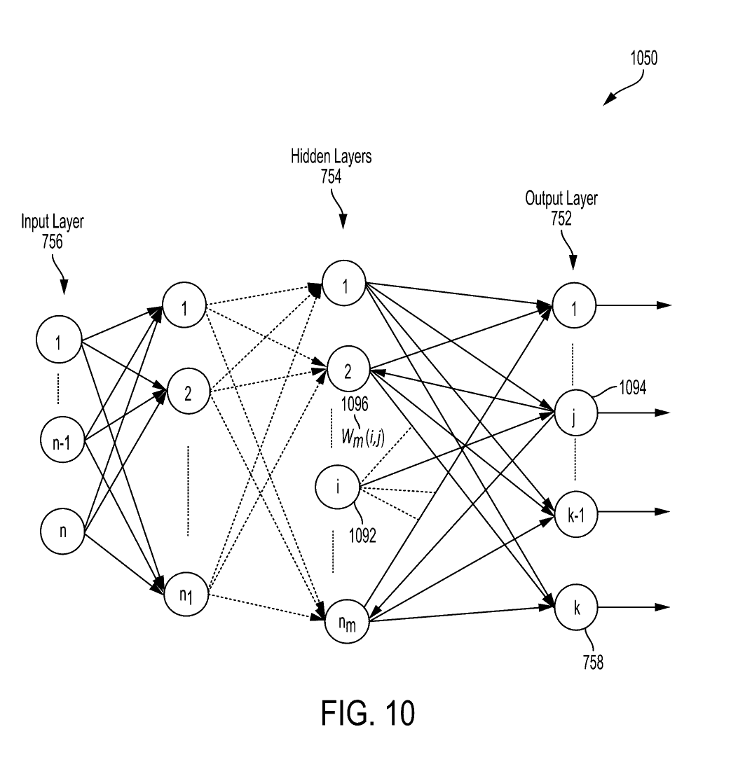

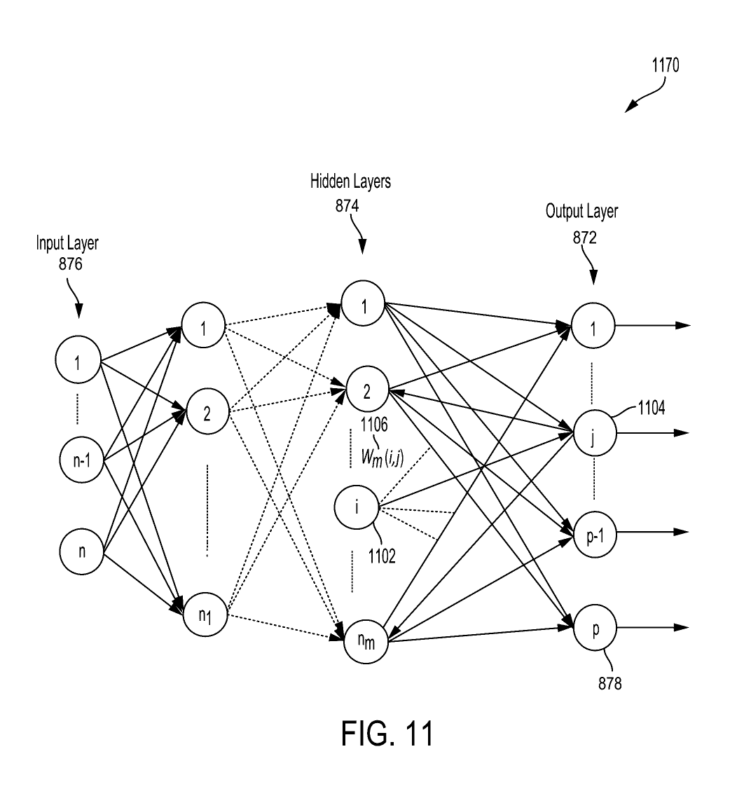

The multilevel classifier is not limited to the illustrated connection topologies. The multilevel classifier may be used to determine confidence indicators or qualification scores. For example, a system can classify a resource (e.g., a service agent) into a classification level (e.g., a suitability level) and determine a corresponding confidence indicator, which can provide additional insight into the classification level. FIGS. 10-11 depict examples of the intra-level values and confidence indicators being determined for the neural network architectures 750 and 870, respectively of FIG. 7 and FIG. 8.

FIG. 10 is a block diagram of an example of the neural network architecture 750 in FIG. 7 annotated as the neural network architecture 1050 for illustrating an example of a derivation of an intra-level value for determining a confidence indicator or a qualification score. A weight 1096 of the i^{th} node 1092 at the m^{th} hidden layer 754 connected by an edge to the j^{th} node 1094 of the output layer 752 can be described as wₘ(i,j), where 1≦i≦nₘ, 1≦j≦k, and 1<k. An output of the i^{th} node 1092 at the m^{th} hidden layer can be described as oₘ(i).

In some aspects, a confidence indicator can be determined for the classification level. The confidence indicator for the j^{th} node 1094 when the j^{th} level is indicated can be formulated as

$$ci ( j ) = ( \frac{{\sum }_{t \neq j} {\sum }_{i = 1}^{{n}_{m}} {o}_{m} ( i ) \times {w}_{m} ( i , t )}{k - 1} , {\sum }_{i = 1}^{{n}_{m}} {o}_{m} ( i ) \times {w}_{m} ( i , j ) ) .$$

The average of all the input values used in the output nodes 758 except the output node j 1094 can be described as zero(j) such that

$$zero ( j ) = \frac{{\sum }_{t \neq j} {\sum }_{i = 1}^{{n}_{m}} {o}_{m} ( i ) \times {w}_{m} ( i , t )}{k - 1} .$$

The input value used to trigger the output node j 994 to 1 can be described as one(j) such that one(j)=Σᵢ₌₁ⁿ^{ₘ} oₘ(i)×wₘ(i,j). Thus, a formula for the confidence indicator can be written as ci(j)=(zero(j), one(j)).

The confidence indicator can provide a quantitative comparison between two resources (e.g., two service agents) that receive the same classification. For example, a confidence indicator of a first resource being a specific classification j̅ can be higher than a second resource being classified to the same classification j if zero (j̅)<<zero(j) and a one (j)<<one(j̅), where zero(j̅) and one(j̅) are the confidence indicator values associated with the first resource and zero (j) and one (j) are the confidence indicator values associated with the second resource. Other relationships between ci(j̅) and ci(j) can be interpreted accordingly. In some examples, the quality of a zero(j) value and a one(j) value can be evaluated based on a variance of their contributing elements.

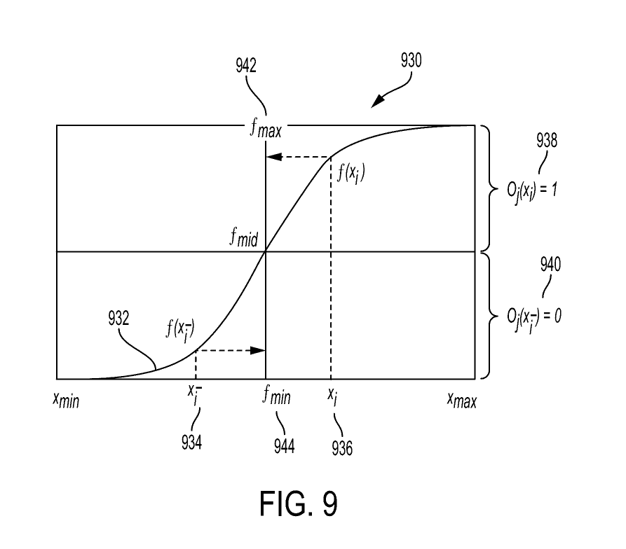

To determine a qualification score, the nodes at the output layer 752 can have an activation function of the form shown in FIG. 9. In FIG. 9, let f(*) 932 be a sigmoidal type of activation function. Although FIG. 9 depicts a sigmoidal activation function, an activation function can take on a different shape. For example, f(*) can be a step type of activation function. The activation function f(*) 932 takes input such as xᵢ 936 and x_{ī}934. Each such input comprises in part the weighted outputs of nodes of previous layer and a bias associated with the output node j such as 1094 of FIG. 10 or 1104 of FIG. 11 where the activation function resides. The output of the activation function f(*) 932 has a bounded range fₘₐₓ 942 and fₘᵢₙ 944 and can be mapped into a binary output value such as 938 and 940 using the following formula or a variant of it:

$${O}_{j} ( x ) = \{ \begin{matrix}1 & for {f}_{mid} < f ( x ) \leq {f}_{max} \\ 0 & for {f}_{min} \leq f ( x ) \leq {f}_{mid}\end{matrix}$$

Let x(j)=bⱼ+Σᵢ₌₁ⁿ^{ₘ} oₘ(i)×wₘ(i,j) be the input of the activation function of node j at the output layer 752 in FIG. 10, where bⱼ is the bias of the node j 1094. Let mf (x(j)), a modified function of the activation function f(x(j)) 932 of node j 1094, be defined as follows:

$$mf ( x ( j ) ) = \{ \begin{matrix}\frac{f ( x ( ) ) - {f}_{mid}}{{f}_{max} - {f}_{mid}} & if {f}_{max} \geq f ( x ( j ) ) > {f}_{mid} \\ \frac{{f}_{mid} - f ( x ( j ) )}{{f}_{mid} - {f}_{min}} & if {f}_{mid} \geq f ( x ( j ) ) \geq {f}_{min}\end{matrix}$$

When a qualification level value is j, its corresponding intra-level value (il(j)) is then given as follows:

$$il ( j ) = {\sum }_{t = 1}^{k} \frac{mf ( x ( t ) )}{k}$$

The intra-level value (il(j)) is bounded between zero and one. When it is close to one, the qualification score should be at the higher end of the score range. Conversely, when it is close to zero, the qualification score should be at the lower end of the score range. To account for such indication, the contributing factors of (il(j)), for examples, can be computed as described above or in one of the following manners:

$$il ( j ) = {\sum }_{t = 1 , t \neq j}^{k} \frac{mf ( x ( t ) )}{k - 1} ,$$

excluding the contribution of node j;

il(j)=il(j,j)=mf(x(j)),

considering only the contribution from node j; or

il(j)=il(j, 1, . . . j−1)·w_{1, . . . j-1}+il(j, j)·wⱼ+il(j, j+1, . . . ,)·w_{j+1, . . . k}

weighing different contributions differently, where

$$il ( j , 1 , … j - 1 ) = \{ \begin{matrix}{\sum }_{t = 1}^{j - 1} \frac{mf ( x ( t ) )}{j - 1} & if j > 0 \\ 0 & if j = 1\end{matrix} ; \\ il ( j , j + 1 , … j - 1 ) = \{ \begin{matrix}{\sum }_{t = j + 1}^{k} \frac{mf ( x ( t ) )}{k - j} & if j < k \\ 0 & if j = k\end{matrix} ; \\ 0 \leq {w}_{1 , … j - 1} \leq 1 ; 0 \leq {w}_{j} \leq 1 ; 0 \leq {w}_{j + 1 , … k} \leq 1 ; and \\ 0 \leq {w}_{1 , … j - 1} + {w}_{j} + {w}_{j + 1 , … k} \leq 1.$$

A qualification score can be determined from the classification level j and the intra-level value il(j). In some aspects, the qualification score for the classification level can be mapped to a value within a range from sⱼₘᵢₙ to sⱼₘₐₓ. The qualification score can be calculated as

QualificationScore(j, il(j))=sⱼₘᵢₙ+(sⱼₘₐₓ−sⱼₘᵢₙ)*il(j)

or

QualificationScore(,il(j))=sⱼₘₐₓ*il(j)+sⱼₘᵢₙ*(1−il(j))

FIG. 11 is a block diagram of an example of the neural network architecture 870 in FIG. 8 annotated as the neural network architecture 1170 for illustrating another example of a derivation of a confidence indicator. The weight 1106 of the i^{th} node 1102 at the m^{th} hidden layer 874 going to the j^{th} node 1104 of the output layer 872 can be described as wₘ(i,j), where 1≦i≦nₘ, 1≦j≦p. The output of the i^{th} node 1102 at the m^{th} hidden layer can be described as oₘ(i).

The bit value of the output node j 1104 at the output layer 872 can be described as Oⱼ such that the confidence indicator for the classification level O₁ O₂ . . . Oₚ can be formulated as follows:

$$ci ( {O}_{1} {O}_{2} … {O}_{p} ) = ( \begin{matrix}\frac{{\sum }_{{O}_{j} = 0 , 1 \leq j \leq p} {\sum }_{i = 1}^{{n}_{m}} {o}_{m} ( i ) \times {w}_{m} ( i , j )}{{\sum }_{{O}_{j} = 0 , 1 \leq j \leq p} 1} , \\ \frac{{\sum }_{{O}_{j} = 1 , 1 \leq j \leq p} {\sum }_{i = 1}^{{n}_{m}} {o}_{m} ( i ) \times {w}_{m} ( i , j )}{{\sum }_{{O}_{j} = 1 , 1 \leq j \leq p} 1}\end{matrix} ) ,$$

when not all Oᵢ=0 and not all Oⱼ=1 (e.g., when the classification level is binary 0101);

$$ci ( {O}_{1} {O}_{2} … {O}_{p} ) = ( \frac{{\sum }_{{O}_{j} = 0 , 1 \leq j \leq p} {\sum }_{i = 1}^{{n}_{m}} {o}_{m} ( i ) \times {w}_{m} ( i , j )}{{\sum }_{{O}_{j} = 0 , 1 \leq j \leq p} 1} , ) ,$$

when all Oⱼ=0 (e.g., when the classification level is binary 0000); and

$$ci ( {O}_{1} {O}_{2} … {O}_{p} ) = ( , \frac{{\sum }_{{O}_{j} = 1 , 1 \leq j \leq p} {\sum }_{i = 1}^{{n}_{m}} {o}_{m} ( i ) \times {w}_{m} ( i , j )}{{\sum }_{{O}_{j} = 1 , 1 \leq j \leq p} 1} ) ,$$

when all Oⱼ=1 (e.g., when the classification level is binary 1111). The average of all the input values used in the output nodes 878 each of which produces an output value of 0 can be described as [symbol] (O₁ O₂ . . . Oₚ), where

$$( {O}_{1} {O}_{2} … {O}_{p} ) = \frac{{\sum }_{{O}_{j} = 0 , 1 \leq j \leq p} {\sum }_{i = 1}^{{n}_{m}} {o}_{m} ( i ) \times {w}_{m} ( i , j )}{{\sum }_{{O}_{j} = 0 , 1 \leq j \leq p} 1} .$$

The average of the input values used in the output nodes 878 each of which produces an output value of 1 can be described as [symbol] (O₁ O₂ . . . Oₚ), where

$$( {O}_{1} {O}_{2} … {O}_{p} ) = \frac{{\sum }_{{O}_{j} = 1 , 1 \leq j \leq p} {\sum }_{i = 1}^{{n}_{m}} {o}_{m} ( i ) \times {w}_{m} ( i , j )}{{\sum }_{{O}_{j = 1} , 1 \leq j \leq p} 1} ,$$

Such that the confidence indicator can be written as

ci(O₁ O₂ . . . Oₚ)=( [symbol] (O₁ O₂ . . . Oₚ) [symbol] (O₁ O₂ . . . Oₚ)).

The confidence of a first subject being classified level O̅₁̅ O̅₂̅ .̅ .̅ .̅ O̅ₚ̅ can be higher than a second subject being classified to the same O₁ O₂ . . . Oₚ level if [symbol] (O̅₁̅ O̅₂̅ .̅ .̅ .̅ O̅ₚ̅)<< [symbol] (O₁ O₂ . . . Oₚ) and [symbol] (O₁ O₂ . . . Oₚ)<< [symbol] (O̅₁̅ O̅₂̅ .̅ .̅ .̅ O̅ₚ̅), where [symbol] (O̅₁̅ O̅₂̅ .̅ .̅ .̅ O̅ₚ̅) and [symbol] (O̅₁̅ O̅₂̅ .̅ .̅ .̅ O̅ₚ̅) are the confidence indicator values associated with the first subject and [symbol] (O₁ O₂ . . . Oₚ) and [symbol] (O₁ O₂ . . . Oₚ) are the confidence indicator values associated with the second subject. Other relationships between ci(O̅₁̅ O̅₂̅ .̅ .̅ .̅ O̅ₚ̅) and ci(O₁ O₂ . . . Oₚ) can be interpreted accordingly. For example, the quality of a [symbol] (O₁ O₂ . . . Oₚ) value could be evaluated based on the variance of its contributing elements. In additional or alternative examples, the quality of a [symbol] (O₁ O₂ . . . Oₚ) value and a [symbol] (O₁O₂ . . . Oₚ) value could also be evaluated based on the variance of their contributing elements.

Although computing the confidence interval in FIGS. 10-11 includes calculating an average of internal data used to determine the output of output nodes, different functions may be used. For example, a system can use the median of internal data. In some examples, the system can only use internal data above or below a specific threshold.

Alternatively, when the neutral network is used to calculate a qualification score the nodes at the output layer 872 have an activation function of the form shown in FIG. 9. Let x(j)=bⱼ+Σᵢ₌₁ⁿ^{ₘ} oₘ(i)×wₘ(i,j) be the input of the activation function of node j at the output layer 872, where bⱼ is the bias of the node j. Let mf(x(j)), a modified function of the activation function f(x(j)) 932 of FIG. 11 of node j, can be defined as follows:

$$mf ( x ( j ) ) = \{ \begin{matrix}\frac{f ( x ( j ) ) - {f}_{mid}}{{f}_{max} - {f}_{mid}} & if {f}_{max} \geq f ( x ( j ) ) > {f}_{mid} \\ \frac{{f}_{mid} - f ( x ( j ) )}{{f}_{mid} - {f}_{min}} & if {f}_{mid} \geq f ( x ( j ) ) \geq {f}_{min}\end{matrix}$$

When a classification level value is O₁ . . . Oₚ, its corresponding intra-level value (il(O₁ . . . Oₚ)) is then given as follows:

$$il ( {O}_{1} … {O}_{p} ) = {\sum }_{t = 1}^{p} \frac{mf ( x ( t ) )}{p}$$

The intra-level value (il(O₁ . . . Oₚ)) has the same interpretation as for the intra-level value (il(j)) discussed above in regards to FIG. 10 and its contributing factors may also be computed similarly.

A qualification score can be determined from the classification level ((O₁ . . . Oₚ) and the intra-value (il(O₁ . . . Oₚ)). In some aspects, the qualification score for the classification level can be mapped to a value in a range from s_{O}_{_{1 . . .}} _{O}_{ₚ}ₘᵢₙ to sₒ_{_{1 . . .}} _{O}_{ₚ}ₘₐₓ. The value of the qualification score can be calculated as

QualificationScore (O₁ . . . Oₚ, il(O₁ . . . Oₚ))=+s_{O}_{_{1 . . .}} _{O}_{ₚ}ₘᵢₙ+(s_{O}_{_{1 . . .}} _{O}_{ₚ}ₘₐₓ−s_{O}_{_{1 . . .}} _{O}_{ₚ}ₘᵢₙ)*il(O₁ . . . Oₚ)

or

QualificationScore (O₁ . . . Oₚ, il(₁ . . . Oₚ))=s_{O}_{_{1 . . .}} _{O}_{ₚ}ₘₐₓ*il(O₁ . . . Oₚ)+(1−il(O₁ . . . Oₚ))*s_{O}_{_{1 . . .}} _{O}_{ₚ}ₘᵢₙ

The qualification score can provide greater precision between resources than a confidence indicator. All information provided by a confidence indicator is available in the qualification score. In some examples, the qualification score can be determined for a set of resources that passed a compatibility test. In additional or alternative examples, a set of resources with a qualification score above a threshold level can be input to a compatibility test.

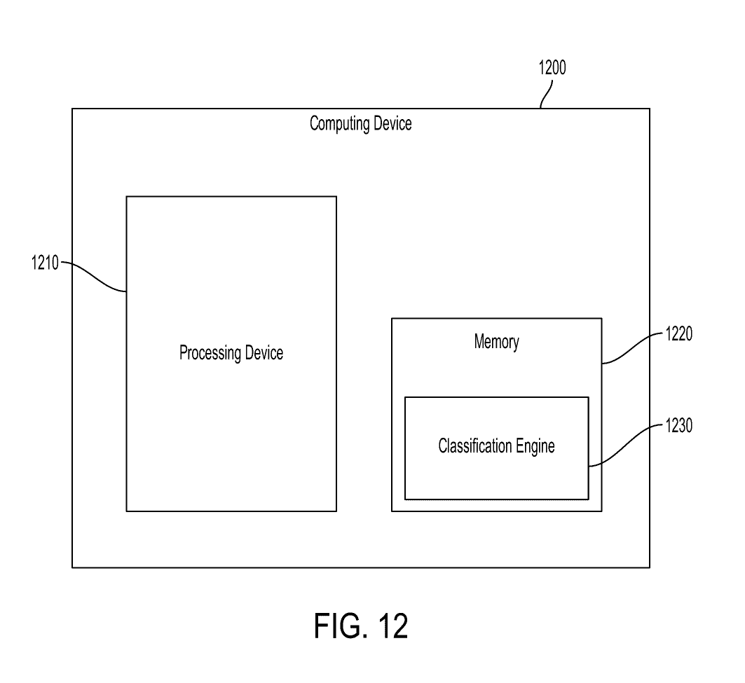

FIG. 12 depicts a computing device 1200 that can determine qualification scores or confidence indicators using multilevel classifiers. The computing device 1200 can include a processing device 1210 and a memory 1220. The processing device 1210 can include any number of processors configured for executing program code stored in the memory 1220. Examples of the processing device 1210 can include a microprocessor, an application-specific integrated circuit (“ASIC”), a field-programmable gate array (“FPGA”), or other suitable processor. In some aspects, the processing device 1210 can be a dedicated processing device used for determining confidence indicators or qualification scores of a classification of multilevel classifiers. For example, the processing device 1210 can be communicatively coupled to a neural network that operates as a multilevel classifier such that the processing device 1210 can monitor the output of the neural network and determine intra-level values of the neural network. In other aspects, the processing device 1210 can perform functions in addition to determining confidence indicators or qualification scores such as training neural networks. In additional or alternative aspects, the processing device 1210 can perform compatibility tests to determine a compatibility score for a client and a resource.

The processing device can include (or be communicatively coupled with) a non-transitory computer-readable memory 1220. The memory 1220 can include one or more memory devices that can store program instructions. The program instruction can include for example, a classification engine 1230 that is executable by the processing device to perform certain operations described herein.

The operations can include determining intra-level values used in computing an output of a classifier. The operations can further include computing confidence indicators associated with the output based on the intra-level values. For example, a confidence indicator associated with a chosen classification level can be computed based on an average of all the values used to determine the classification level other than the chosen classification level. Computing can be further based on an average of the values used to determine the chosen classification level. The operations can further include computing a qualification score associated with a chosen classification level.

In some aspects, the qualification score and confidence indicator computations illustrated can take different forms based on outputs and weights of the last hidden layers. For example, a system can scale the value of the output based on a linear or nonlinear function. In additional or alternative examples, a system can use minimum and maximum functions in a selection of outputs and weights of the last hidden layers. In additional or alternative aspects, the qualification score or confidence indicator computations can be based on outputs and weights of any node in the hidden layer including a first node of the hidden layer. Although the term “multilevel” is illustrated as having multiple classification levels, the term “multilevel” is used herein to describe a classifier with one or more classification levels. For example, a multilevel classifier can apply to a system with a single output having two possible values and a confidence indicator or a qualification score can be used to provide a degree of certainty.

In some aspects, classifying resources using an intra-level values of a multilevel classifier can be provided according to one or more of the following examples:

### EXAMPLE #1

A method of filtering and scoring a plurality of resources can be performed for resources associated with a plurality of attribute values. For each resource, the method can include applying a subset of the attribute values to an input layer of a multilevel classifier. The multilevel classifier can include a plurality of layers and each layer can include a plurality of nodes. For each resource, the method can further include using the multilevel classifier to generate a plurality of output values at an output layer of the multilevel classifier. The output values can each be associated with an output node and can be generated using an activation function. The inputs to the activation function can include weighted outputs from nodes in a previous layer and a bias associated with the output node. For each output value, the method can further include generating an intra-level value using an output from at least one node in the previous layer and a modified activation function. For each output value, the method can further include using the plurality of output values and associated intra-level values to determine a qualification score for the resource. The method can further include using the qualification scores for the resources to filter the resources.

### EXAMPLE #2

The method of Example #1 can further include receiving a set of requirements. The method can further include determining that a portion of the resources with the highest qualification scores are potential resources. For each potential resource, the method can further include comparing the set of requirements with at least a portion of the attribute values to generate a compatibility score. For each potential resource, the method can further include using the compatibility scores to filter the potential resources.

### EXAMPLE #3

The method of Example #2 can further include, for each potential resource, comparing the compatibility score to a threshold value to determine if the resource is compatible. Using the compatibility scores to filter the potential resources can include creating a set of qualified resources. The qualified resources being potential resources that are compatible.

### EXAMPLE #4

The method of Example #3 can further include, providing information associated with each qualified resource to a user. The method can further include updating an attribute value for a selected resource of the qualified resources in response to a selection of one of the qualified resources.

### EXAMPLE #5

The method of Example #4 can further include, using the qualification score and the attribute values for the selected resource to further train the multilevel classifier.

### EXAMPLE #6

The method of Example #2 can further feature, representing the set of requirements by a normalized vector and the portion of the attribute values for each potential resource by a normalized resource vector. Comparing the set of requirements with at least a portion of the attribute values can generate a compatibility score that includes using at least one of cosine similarity, distance measure, and length measure.

### EXAMPLE #7

The method of Example #1 can further feature, the plurality of resources as resources that passed a compatibility test.

### EXAMPLE #8

The method of Example #1 can further feature, using the qualification scores for the resources to filter the resources including determining a set of qualified resources, the qualified resources being the resources having the qualification score exceeding a threshold value.

### EXAMPLE #9

A method for evaluating a plurality of resources can include receiving a set of requirements. The method can further include comparing the set of requirements to the plurality of the resources by comparing a weighted set of attributes representing the set of requirements with a set of attributes for each of the resources. The method can further include selecting a subset of the resources based on the comparison. The method can further include, for each resource of the subset of the resources, applying at least some of the attributes of the resource to a multilevel classifier that includes a plurality of layers. Each layer can include a plurality of nodes. The method can further include using the multilevel classifier to generate a plurality of output values and a plurality of intra-level values. The output values can be associated with nodes at an output layer of the multilevel classifier and the intra-level values can be associated with a node in a previous layer. The output values can indicate a classification level for the resource.

### EXAMPLE #10

The method of Example #9 can further include calculating a qualification score for each resource of the subset of the resources using the output values and the intra-level values. The method can further include filtering the subset of the resources to identify resources with qualification scores exceeding a threshold level. The method can further include providing information associated with the identified resources to a user. The method can further include updating an attribute value for a selected resource in response to a selection of one of the identified resources by the user. The method can further include using the qualification score for the selected resource of the identified resources to further train the multilevel classifier.

### EXAMPLE #11

The method of Example #9 can further feature the resources being service agents and the user being an auditor. Receiving the set of requirements can include receiving preferences from the auditor. The method can further include providing a communication channel between the auditor and a selected service agent.

### EXAMPLE #12

The method of Example #9 can further feature the resources being auditors and the user being a client. Receiving the set of requirements can include receiving preferences from the client. The method can further include providing a communication channel between the client and a selected auditor.

### EXAMPLE #13

The method of Example #11 can further include, for each resource, computing a confidence indicator associated with the output values based in part on an average of outputs of nodes in the previous layer. The method can further include using the confidence indicators for the resources to filter the resources.

### EXAMPLE #14

The method of Example #13 can further feature computing the confidence indicator including normalizing the outputs of the previous layer.

### EXAMPLE #15

A non-transitory computer-readable medium having instructions stored thereon that are executable by a processing device to perform operations, can include operations for maintaining a database of information associated with resources, each resource having a plurality of attributes. The operations can further include receiving a set of requirements. The operations can further include using a weighted set of attributes to represent the set of requirements. The method can further include comparing the weighted set of attributes to the attributes of each of the resources using at least one of cosine similarity, distance measure, and length measure to identify a subset of the resources.

### EXAMPLE #16

The operations of Example #15 can further include using a multilevel classifier to generate a qualification score for each resource of the subset of the resources. The multilevel classifier can include a plurality of layers, each layer including a plurality of nodes. The multilevel classifier can generate a plurality of output values and a plurality of intra-level values for each resource of the plurality of the resources. The qualification score can be based on the output values and the intra-level values. The operations can further include using the qualification scores to further train the multilevel classifier.

### EXAMPLE #17

The operations of Example #16 can further feature the plurality of output values representing a classification level for each resource. The plurality of intra-level values can be generated based on intermediate data used by the multilevel classifier to determine the classification level.

### EXAMPLE #18

The operations of Example #17 can further include determining a portion of the subset of the resources based on the resources in the portion having a qualification score that exceeds a threshold level. The operations can further include providing information associated with the resources in the portion to a user. The operations can further include updating an attribute value for a selected resource of the portion in response to a selection of one of the resource by the user.

### EXAMPLE #19

The operations of Example #15 can further include, for each resource, computing a confidence indicator associated with the plurality of output values based in part on an average of outputs of nodes in a previous layer. The operations can further include using the confidence indicators for the resources to filter the resources.

### EXAMPLE #20

The operations of Example #19 can further feature computing the confidence indicator including normalizing the outputs of the previous layer.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A method of filtering and scoring a plurality of resources, wherein each resource is associated with a plurality of attribute values, comprising:
for each resource:
applying at least a subset of the attribute values to an input layer of a multilevel classifier, wherein the multilevel classifier includes a plurality of layers, each layer including a plurality of nodes;
using the multilevel classifier to generate a plurality of output values at an output layer of the multilevel classifier, wherein each output value is associated with an output node and is generated using an activation function, wherein inputs to the activation function include weighted outputs from nodes in a previous layer and a bias associated with the output node;
for each output value:
generating an intra-level value using an output from at least one node in the previous layer and a modified activation function; and
using the plurality of output values and associated intra-level values to determine a qualification score for the resource; and
using the qualification scores for the resources to filter the resources.

2. The method of claim 1, further comprising:
receiving a set of requirements;
determining that a portion of the resources with the highest qualification scores are potential resources;
for each potential resource:
comparing the set of requirements with at least a portion of the attribute values to generate a compatibility score; and
using the compatibility scores to filter the potential resources.

3. The method of claim 2, further comprising:
for each potential resource:
comparing the compatibility score to a threshold value to determine if the resource is compatible,
wherein using the compatibility scores to filter the potential resources comprises creating a set of qualified resources, the qualified resources being potential resources that are compatible.

4. The method of claim 3, further comprising:
providing information associated with each qualified resource to a user; and
updating an attribute value for a selected resource of the qualified resources in response to a selection of one of the qualified resources.

5. The method of claim 4, further comprising:
using the qualification score and the attribute values for the selected resource to further train the multilevel classifier.

6. The method of claim 2, wherein the set of requirements are represented by a normalized vector and the portion of the attribute values for each potential resource is represented by a normalized resource vector, and wherein comparing the set of requirements with at least a portion of the attribute values to generate a compatibility score comprises using at least one of cosine similarity, distance measure, and length measure.

7. The method of claim 1, wherein the plurality of resources are resources that passed a compatibility test.

8. The method of claim 1, wherein using the qualification scores for the resources to filter the resources comprises determining a set of qualified resources, the qualified resources being the resources having the qualification score exceeding a threshold value.

9. A method for evaluating a plurality of resources, comprising:
receiving a set of requirements;
comparing the set of requirements to the plurality of the resources by comparing a weighted set of attributes representing the set of requirements with a set of attributes for each of the resources;
based on the comparison, selecting a subset of the resources;
for each resource of the subset of the resources:
applying at least some of the attributes of the resource to a multilevel classifier that includes a plurality of layers, each layer including a plurality of nodes; and
using the multilevel classifier to generate a plurality of output values and a plurality of intra-level values, wherein the output values are associated with nodes at an output layer of the multilevel classifier and the intra-level values are associated with a node in a previous layer, the output values indicating a classification level for the resource.

10. The method of claim 9, further comprising:
calculating a qualification score for each resource of the subset of the resources using the output values and the intra-level values;
filtering the subset of the resources to identify resources with qualification scores exceeding a threshold level;
providing information associated with the identified resources to a user;
updating an attribute value for a selected resource in response to a selection of one of the identified resources by the user; and
using the qualification score for the selected resource of the identified resources to further train the multilevel classifier.

11. The method of claim 9, wherein the resources are service agents, wherein the user is an auditor, wherein receiving the set of requirements comprises receiving preferences from the auditor, the method further comprising:
providing a communication channel between the auditor and a selected service agent.

12. The method of claim 9, wherein the resources are auditors, wherein the user is a client, wherein receiving the set of requirements comprises receiving preferences from the client, the method further comprising:
providing a communication channel between the client and a selected auditor.

13. The method of claim 8, further comprising:
for each resource:
computing a confidence indicator associated with the output values based in part on an average of outputs of nodes in the previous layer; and
using the confidence indicators for the resources to filter the resources.

14. The method of claim 13, wherein computing the confidence indicator includes normalizing the outputs of the previous layer.

15. A non-transitory computer-readable medium having instructions stored thereon that are executable by a processing device to perform operations, the operations comprising:
maintaining a database of information associated with resources, each resource having a plurality of attributes;
receiving a set of requirements;
using a weighted set of attributes to represent the set of requirements; and
comparing the weighted set of attributes to the attributes of each of the resources using at least one of cosine similarity, distance measure, and length measure to identify a subset of the resources.

16. The operations of claim 15, further comprising:
using a multilevel classifier to generate a qualification score for each resource of the subset of the resources, wherein the multilevel classifier includes a plurality of layers, each layer including a plurality of nodes, and wherein the multilevel classifier generates a plurality of output values and a plurality of intra-level values for each resource of the plurality of the resources, and the qualification score is based on the output values and the intra-level values; and
using the qualification scores to further train the multilevel classifier.

17. The operations of claim 16, wherein the plurality of output values represent a classification level for each resource, wherein the plurality of intra-level values are generated based on intermediate data used by the multilevel classifier to determine the classification level.

18. The operations of claim 17, further comprising:
determining a portion of the subset of the resources based on the resources in the portion having the qualification score that exceeds a threshold level;
providing information associated with the resources in the portion to a user;
updating an attribute value for a selected resource of the portion in response to a selection of one of the resource by the user.

19. The operations of claim 15, further comprising:
for each resource:
computing a confidence indicator associated with the plurality of output values based in part on an average of outputs of nodes in a previous layer; and
using the confidence indicators for the resources to filter the resources.

20. The method of claim 19, wherein computing the confidence indicator includes normalizing the outputs of the previous layer.
